(19) United States
(12) Patent Application Publication
(10) Pub. No.: US 2025/0177108 A1
(43) Pub. Date: Jun. 5, 2025

(54) PASSIVE VOLUNTARY POSITIONING OF ANIMAL FOR MICROSCOPY

(71) Applicant: Howard Hughes Medical Institute, Chevy Chase, MD (US)

(72) Inventor: Maksym Manakov, Ashburn, VA (US)

(21) Appl. No.: 18/953,535

(22) Filed: Nov. 20, 2024

Related U.S. Application Data
(60) Provisional application No. 63/601,830, filed on Nov. 22, 2023.

(51) Int. Cl. A61D 3/00

(52) U.S. Cl. CPC A61D 3/00; A61D 2003/003

(57) ABSTRACT

A coupling apparatus passively positions a portion of an animal relative to an experimental apparatus. The coupling apparatus includes: an animal plate fixed to the animal portion, the animal plate including a plurality of first elements; and a mounting stage fixed relative to the experimental apparatus. The mounting stage includes a wall structure defining an animal opening large enough to accommodate the animal portion and a plate opening sized to accommodate the animal plate, the wall structure including a plurality of second elements. When the animal portion travels though the animal opening, the animal plate is passively guided through the plate opening until each first element is passively coupled with a respective second element such that the animal plate and the mounting stage are mechanically and passively coupled together to form a kinematic mount.

### CROSS REFERENCE TO RELATED APPLICATION

This application claims priority to U.S. Application No. 63/601,830, filed Nov. 22, 2023 and titled PASSIVE VOLUNTARY POSITIONING OF ANIMAL FOR MICROSCOPY, which is incorporated herein by reference in its entirety.

### TECHNICAL FIELD

The disclosed subject matter relates to passive and voluntary positioning of a live animal.

### BACKGROUND

Positioning of a live animal in a fixed location can be required in neuroscience for experimental purposes such as for stimulus control, behavioral monitoring, and neural recording and perturbation experiments. The positioning of the live animal in the fixed location reduces motion between the animal and the equipment performing the experiments.

### SUMMARY

In some general aspects, a coupling apparatus is configured to passively position a portion of an animal relative to an experimental apparatus. The coupling apparatus includes: an animal plate fixed to the animal portion, the animal plate including a plurality of first elements; and a mounting stage fixed relative to the experimental apparatus. The mounting stage includes a wall structure defining an animal opening large enough to accommodate the animal portion and a plate opening sized to accommodate the animal plate, the wall structure including a plurality of second elements. When the animal portion travels though the animal opening, the animal plate is passively guided through the plate opening until each first element is passively coupled with a respective second element such that the animal plate and the mounting stage are mechanically and passively coupled together to form a kinematic mount.

Implementations can include one or more of the following features. For example, the animal portion can be the head of the animal and the animal plate can be fixed to head. Each first element of the animal plate can be a portion of a sphere. Each first element can be made of a metal or metal alloy. Each second element can be made of a metal or metal alloy. Each first element can be made of a non-magnetic metal or metal alloy. Each first element can be made of a stainless steel or titanium. The animal plate can include three first elements and the wall structure can include three second elements. The animal plate can have a triangular shape and each of the first elements can be fixed at a respective corner of the plate. Each second element can be a pair of parallel-aligned and spaced cylinders. Each first element can be a portion of a sphere. There can be one point of contact between the sphere portion and a first cylinder of the respective pair of cylinders and there can be one point of contact between the sphere portion and a second cylinder of the respective pair of cylinders when the sphere portion is passively coupled with the respective pair of cylinders. The animal plate can include three first elements and the wall structure can include three second elements. The cylinders of a first pair of cylinders can have axes that are parallel with a mounting direction and the cylinders of second and third pairs of cylinders can have axes that are perpendicular with the mounting direction and perpendicular with the axes of the first pair of cylinders. The animal plate and the mounting stage can be mechanically and passively coupled together to form the kinematic mount without the use of an external force to couple them together. The experimental apparatus can be a microscope and the animal plate can extend along a plate plane and the plate plane can be parallel with an imaging plane of the microscope when the animal plate and the mounting stage are mechanically and passively coupled together to form the kinematic mount. When the animal plate and the mounting stage are mechanically and passively coupled together to form the kinematic mount, the position of the animal portion can be fixed with a precision in a range of 1-40 (micrometers) μm, a range of 1-20 μm, or a range of 1-10 μm in the imaging plane and with a precision in a range of 1-5 μm in a direction perpendicular to the imaging plane.

The coupling apparatus can further include a current supply system in electrical communication with each second element. An electrical circuit can be completed between each second element and the respective first element when the animal plate and the mounting stage are mechanically and passively coupled together to form the kinematic mount. The coupling apparatus can also include a reward system configured to sense when the animal plate and the mounting stage are mechanically and passively coupled together to form the kinematic mount and to provide a reward to the animal when it is sensed that the animal plate and the mounting stage are mechanically and passively coupled together to form the kinematic mount. The coupling apparatus can also include a guide system configured to passively constrain the animal plate as it is guided through the plate opening. The guide system can include a set of angled walls of the wall structure, the angled walls tapering along a mounting direction.

When the animal plate and the mounting stage are mechanically and passively coupled together to form a kinematic mount, the animal can be free to move along a path that is the opposite to a mounting direction but the animal can be constrained to translate in the mounting direction or along directions that are transverse to the mounting directions. The experimental apparatus can be a microscope, and the animal plate can extend along a plate plane and the plate plane can align with an imaging plane of the microscope when the animal plate and the mounting stage are mechanically and passively coupled together to form the kinematic mount. The animal can be constrained from rotating about an axis that is perpendicular to the imaging plane and can be constrained from rotating about an axis that is parallel with the mounting direction when the animal plate and the mounting stage are mechanically and passively coupled together to form the kinematic mount.

The details of one or more implementations are set forth in the accompanying drawings and the description below. Other features will be apparent from the description and drawings, and from the claims.

### DESCRIPTION OF DRAWINGS

The accompanying drawings, which are incorporated herein and form part of the specification, illustrate the present disclosure and, together with the description, further serve to explain the principles of the present disclosure and to enable a person skilled in the relevant art(s) to make and use implementations described herein.

FIG. 1A is a schematic block diagram of a coupling apparatus for passively positioning a portion of an animal relative to an experimental apparatus;

FIG. 1B is a schematic block diagram of the coupling apparatus of FIG. 1A, in which the animal portion is passively positioned relative to the experimental apparatus;

FIG. 1C is a close-up view of the coupling apparatus of FIG. 1B, showing details of the animal portion passively positioned relative to the experimental apparatus;

FIGS. 2A and 2B are perspective views of an implementation of an animal plate that can be used in the coupling apparatus of FIGS. 1A-1C, the animal plate being fixed to the animal portion;

FIG. 2C is a plan view of the animal plate of FIG. 2A;

FIG. 2D is another plan view of the animal plate of FIG. 2A;

FIG. 3A is a perspective view of an implementation of a wall structure that can be used in the coupling apparatus of FIGS. 1A-1C, the wall structure being fixed relative to the experimental apparatus and including a base structure and an element structure;

FIG. 3B is a plan view of the wall structure of FIG. 3A;

FIG. 3C is a cross-sectional view of the wall structure of FIG. 3A;

FIGS. 4A and 4B are perspective views of an implementation of the element structure that can be used in the wall structure of FIGS. 3A-3C;

FIGS. 4C and 4D are side plan views of the element structure of FIGS. 4A and 4B;

FIG. 5A is a perspective view showing the animal plate of FIGS. 2A-2D and the wall structure of FIGS. 3A-4D being mechanically and passively coupled together to form a kinematic mount;

FIGS. 5B and 5C are plan views of the animal plate and the wall structure of FIG. 5A;

FIG. 6A is a perspective view showing the animal plate of FIGS. 2A-2D and the second elements of the element structure of FIGS. 4A-4D, where first elements of the animal plate make contact with the second elements of the element structure;

FIG. 6B is a first plan view of the arrangement of the animal plate and the second elements of the element structure of FIG. 6A;

FIG. 6C is a second plan view of the arrangement of the animal plate and the second elements of the element structure of FIG. 6A, and showing the completion of an electrical circuit completed for each pair of first element and respective second element; and

FIGS. 7A-7C are plan views of the animal plate and element structure, where the element structure includes a guide system that provides a rough and gentle guide to properly seat the animal portion relative to the experimental apparatus.

In the drawings, like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

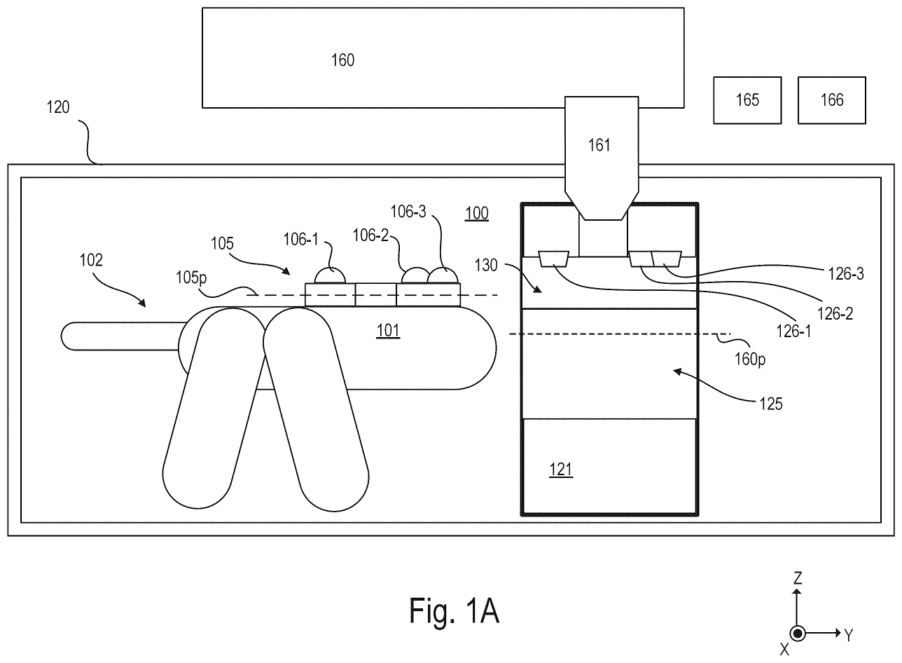

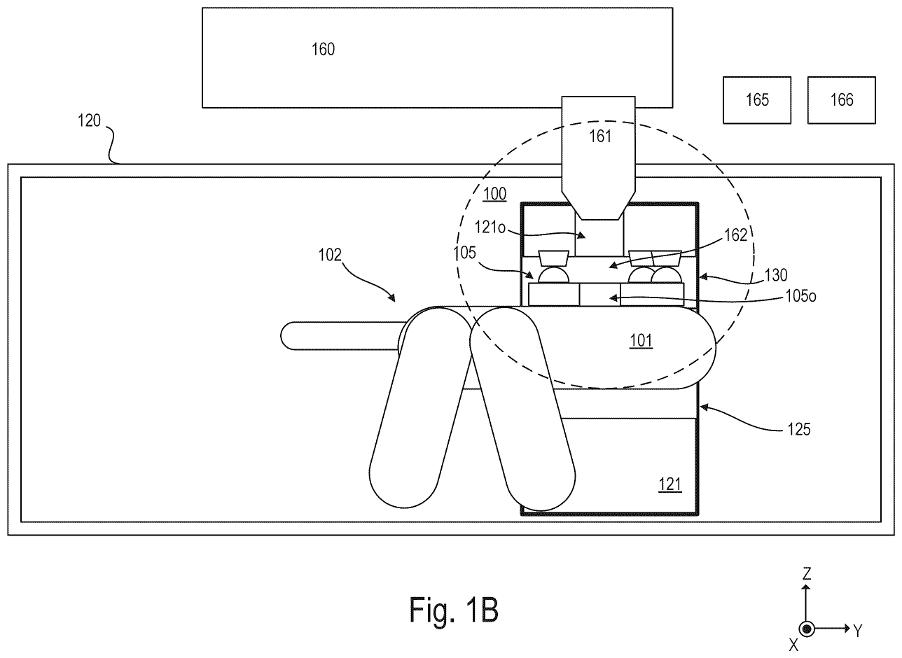

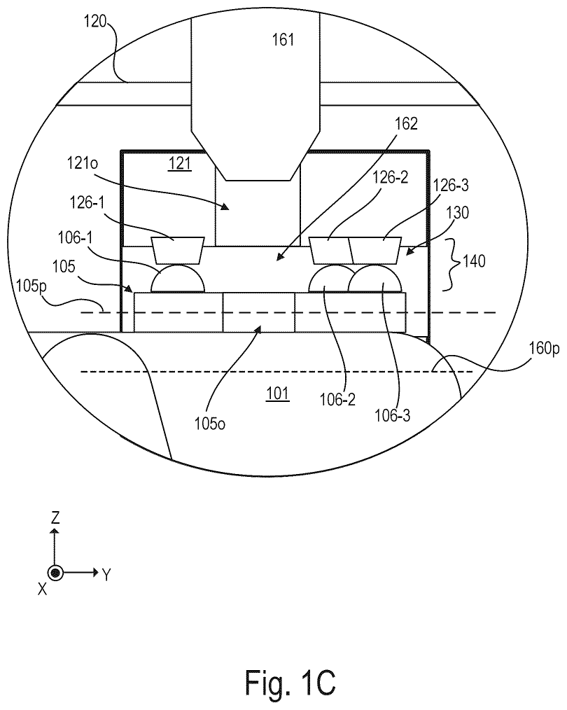

Referring to FIG. 1A, a coupling apparatus 100 is configured relative to an experimental apparatus 160. The coupling apparatus 100 enables the passive positioning of a portion 101 of an animal 102 relative to the experimental apparatus 160. The coupling apparatus 100 enables the animal 102 to voluntary position itself and to couple its animal portion 101 relative to the experimental apparatus 160, as shown in FIGS. 1B and 1C. Such positioning is accomplished without the active clamping or active fixing of the animal portion 101. As the animal 102 moves forward, that is, along a Y direction, the coupling apparatus 100 provides a rough and gentle guide for the animal 102 to enable the animal 102 to properly seat its animal portion 101 relative to the experimental apparatus 160. The X, Y, Z coordinate system shown in FIGS. 1A-1C is the coordinate system of the experimental apparatus 160. The only force needed to couple the animal portion 101 relative to the experimental apparatus 160 is the force provided by the animal 102. This force can include a component along the forward direction (the +Y direction). This force can also include a component along the +Z direction in order to enable posterior coupling between the animal portion 101 and the experimental apparatus 160. Posterior coupling corresponds to the coupling at the posterior of the animal portion 101 with the experimental apparatus 160, as discussed below with reference to FIGS. 5A-5C.

Moreover, while the animal portion 101 is coupled with the experimental apparatus 160 (FIG. 1B), the animal 102 is still able to move the animal portion 101 along the −Y direction to freely disengage or de-couple its animal portion 101 from the experimental apparatus 160. Other than the animal portion 101 being positioned or coupled relative to the experimental apparatus 160, the animal 102 is otherwise a freely moving animal. Any repositioning (disengagement and reengagement) is between the animal portion 101 and the experimental apparatus 160. The coupling apparatus 100 enables this voluntary positioning and coupling without requiring a full-fixation of the animal portion 101. Full fixation means that the animal cannot disengage voluntarily and it is up to the experimenter to release the animal. The coupling apparatus 100 provides all of the benefits of a full fixation of the animal portion 101 relative to the experimental apparatus 160 without the requirement of a full fixation.

The coupling apparatus 100 enables this positioning between the animal portion 101 and the experimental apparatus 160 at a high precision. For example, the animal portion 101 can be fixed so an experimental plane (the XY plane) 160p (FIGS. 1A and 1C) of the experimental apparatus 160 overlaps the animal portion 101 with a precision that is in a range of 1-10 micrometers (μm) and in a direction (the Z direction) that is perpendicular to the XY plane with a precision that is in a range of 1-5 μm. For example, if the experimental apparatus 160 is a microscope, then the range can encompass the size of the features within the animal portion 101 that are being observed by the microscope. One feature that can be observed is the neuron cell body, which is about 5 μm. In this particular example, in which the microscope is configured to observe neuron cell bodies, then the precision should be as good as 5 μm in both the XY plane and the Z direction in order to consistently image the neuron cell bodies.

The coupling apparatus 100 includes an animal plate 105 fixed to the animal portion 101 and a mounting stage 120 fixed relative to the experimental apparatus 160. The animal plate 105 includes a plurality of first elements 106-i, where i is a set of integers from 1 to a maximum number. In the implementation shown, i is the set 1, 2, 3 and there are three first elements 106-1, 106-2, 106-3. The mounting stage 120 includes a wall structure 121 defining an animal opening 125 large enough to accommodate the animal portion 101 and a plate opening 130 having a geometry and size configured to accommodate the animal plate 105. The wall structure 121 also includes a plurality of second elements 126-i, where i is the set of integers from 1 to the maximum number. Thus, in the implementation shown, where i is the set 1, 2, 3, there are second elements 126-1, 126-2, 126-3, and each second element 126-i is associated with a specific and unit first element 106-i when the animal portion 101 is properly positioned relative to the experimental apparatus 160 (as shown in FIG. 1B).

Referring to FIGS. 1B and 1C, when the animal portion 101 travels though the animal opening 125, the animal plate 101 is passively guided through the plate opening 130 until each first element 106-i is passively coupled with a respective second element 126-i such that the animal plate 105 and the mounting stage 120 (and the wall structure 121) are mechanically and passively coupled together to form a kinematic mount 140. No force (other than the force from the animal 102) is needed to couple the animal plate 105 and the wall structure 121 of the mounting stage 120. Once there is mechanical and passive coupling, as shown in FIGS. 1B and 1C, the animal portion 101 is positioned so that it is accessible experimentally to the experimental apparatus 160; that is, the animal portion 101 overlaps the experimental plane 160p. For example, if the experimental apparatus 160 is an optical microscope, then the animal portion 101 is positioned so that light can pass between an objective 161 of the microscope and the animal portion 101 by way of an open pathway 162 defined by an opening 1210 in the wall structure 121 and an opening 1050 in the animal plate 105. The experimental plane (the XY plane) 160p corresponds to an imaging plane of the optical microscope.

In some implementations, the animal 102 is a rodent such as a rat or a mouse and the animal portion 101 corresponds to a head of the rodent such that the experimental apparatus 160 interacts with and analyzes a brain within the head of the rodent. In these implementations, the animal plate 105 is fixed to the rodent's head.

As shown in FIGS. 1B and 1C, when the animal plate 105 and the wall structure 121 of the mounting stage 120 are coupled together, the first element 106-1 contacts the second element 126-1, the first element 106-2 contacts the second element 126-2, and the first element 106-3 contacts the second element 126-2. The animal plate 105 is a generally planar-shaped object that extends within or along a plate plane 105p. The plate plane 105p aligns with and is parallel with the experimental plane (the XY plane) 160p when the animal plate 105 and the mounting stage 120 are coupled together, as shown more clearly in FIG. 1C.

As shown in FIGS. 1A and 1B, the coupling apparatus 100 can also include a current supply system 165 and a reward system 166. The current supply system 165 is in electrical communication with at least one second element 126-i. If the first elements 106-i and the second elements 126-i are made of electrically-conductive materials, then an electrical circuit is completed between the second element 126-i and its respective first element 106-i when the animal plate 105 and the wall structure 121 of the mounting stage 120 are coupled together (such as in FIGS. 1B and 1C). Moreover, the reward system 166 can be in communication with the current supply system 165. The reward system 166 is configured to sense when the animal plate 105 and the wall structure 121 of the mounting stage 120 are coupled together (for example, by determining when the electrical circuit between the second element 126-i and its respective first element 106-i is completed). The reward system 166 is also configured to provide a reward to the animal 102 when it senses that the animal plate 105 and the wall structure 121 of the mounting stage 120 are coupled together. The reward system 166 can therefore use the output of the current supply system 165 in a manner that aligns with the experiment being performed by the experimental apparatus 160.

In some implementations, each of the first elements 106-i and each of the second elements 126-i is made of an electrically-conductive material such as a metal or a metal alloy such as, for example, stainless steel or titanium.

The depiction in FIGS. 1A-1C is schematic and two-dimensional. As discussed below and as shown in the following drawings, the coupling apparatus 100 is three-dimensional and extends along not only the YZ plane (the plane of the page) but also along the X axis (into and out of the page). Moreover, while three first elements and three second elements are shown in FIGS. 1A-1C, it is possible for there to be fewer or more than three first elements and fewer or more than three second elements. In order to form the kinematic mount 140, there should be six points of contact. In the example below, there are three first elements and three second elements, with each second element containing two surfaces (cylinders). Therefore, the entire coupling system is governed by six points of contact. Nevertheless, it is possible to distribute the points of contact differently and have a different number of pairs of first elements, second elements as long as the total number of points of contact is six.

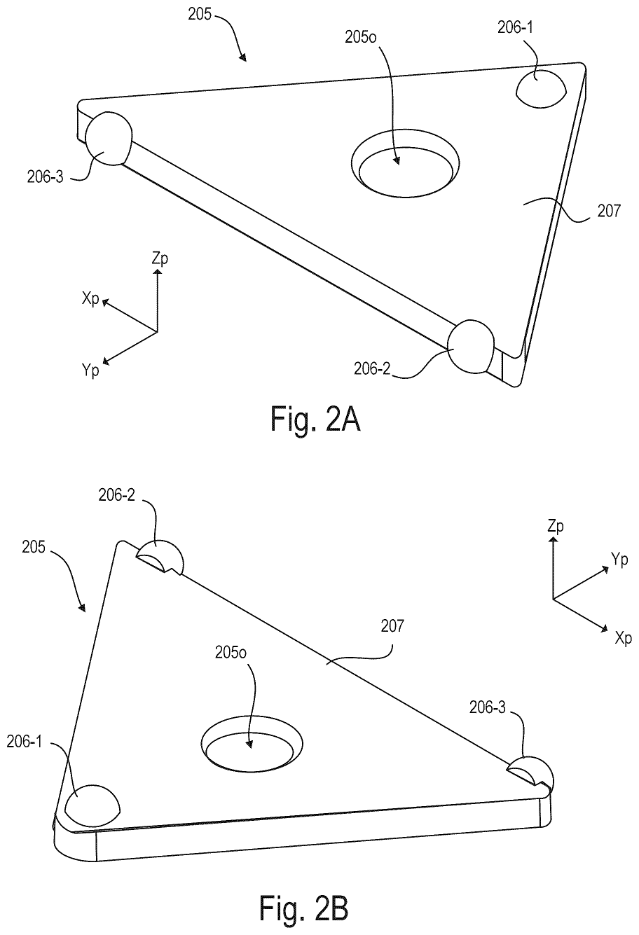

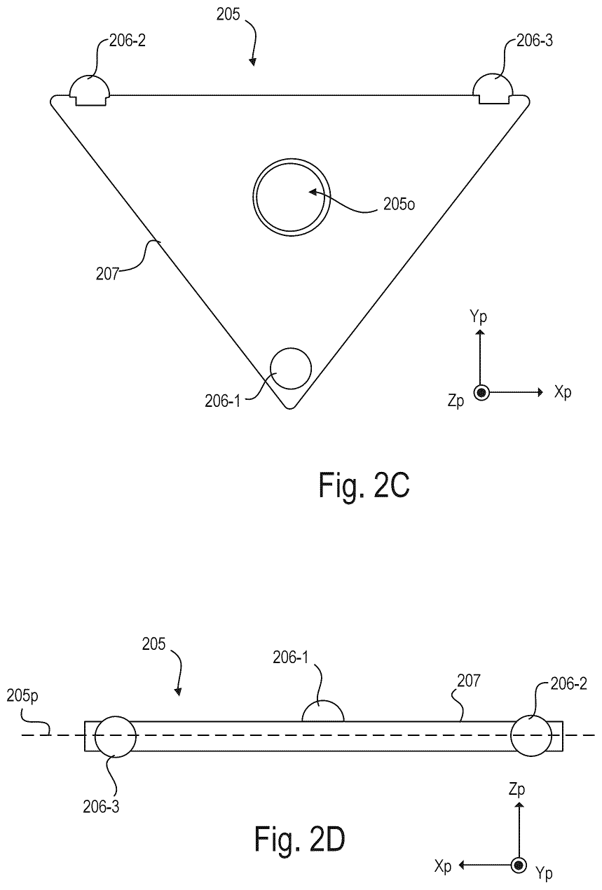

Referring to FIGS. 2A-2D, an implementation 205 of the animal plate 105 is shown along with a local coordinate system Xp, Yp, Zp of the animal plate 205. The local coordinate system Xp, Yp, Zp aligns with the coordinate system X, Y, Z of the mounting stage 120 when the animal plate 205 and the mounting stage 120 are coupled together (such as in FIGS. 1B and 1C). The animal plate 205 is generally shaped like a triangular plate that extends along a plate plane 205p (FIG. 2D0 that is parallel with the XpYp plane. The animal plate 205 includes three first elements 206-1, 206-2, 206-3 fixed to a triangular body 207. Each first element 206-1, 206-2, 206-3 is generally fixed to a region of the body 207 near one of its corners, with the first element 206-1 being arranged at the side of the animal plate 205 that couples with the posterior of the animal portion 101 and the first elements 206-2, 206-3 being arranged at the side of the animal plate 205 that couples with the anterior of the animal portion 101. The animal plate 205 also includes an opening 2050 that aligns with the opening 1210 in the wall structure 121 to form the open pathway 162 when the animal plate 205 and the wall structure 121 of the mounting stage 120 are coupled together (such as in FIGS. 1B and 1C). In this way, the experimental apparatus 160 has access to the animal portion 101 by way of the opening 2050 (and the opening 1210, FIG. 1C).

The triangular body 207 is made of a rigid material and each first element 206-1, 206-2, 206-3 is made of a rigid material. In some implementations, each of the first elements 206-1, 206-2, 206-3 is made of a metal or a metal alloy such as, for example, stainless steel or titanium. In some implementations, each of the first elements 206-1, 206-2, 206-3 is made of a non-magnetic metal or a non-magnetic metal alloy. For example, each of the first elements 206-1, 206-2, 206-3 can be made of a non-magnetic stainless steel or a titanium. Each of the first elements 206-1, 206-1, 206-3 is a portion of a sphere, for example, a hemispherical shape.

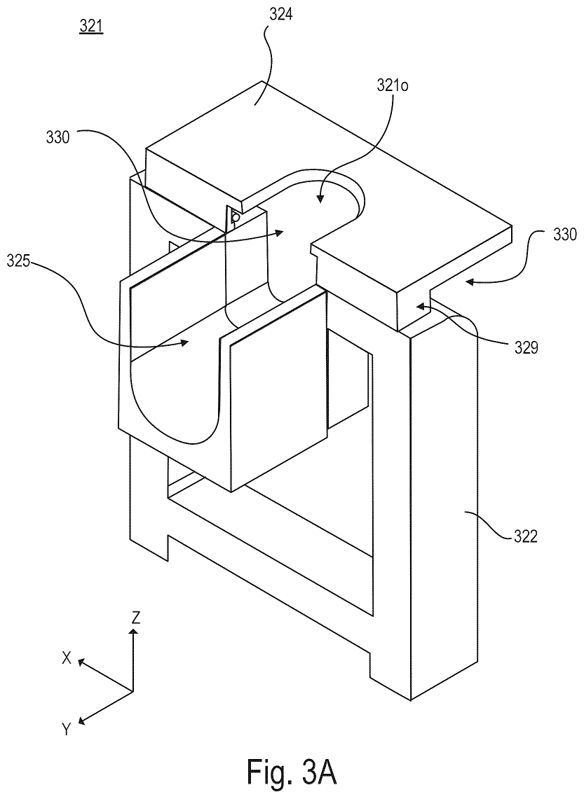

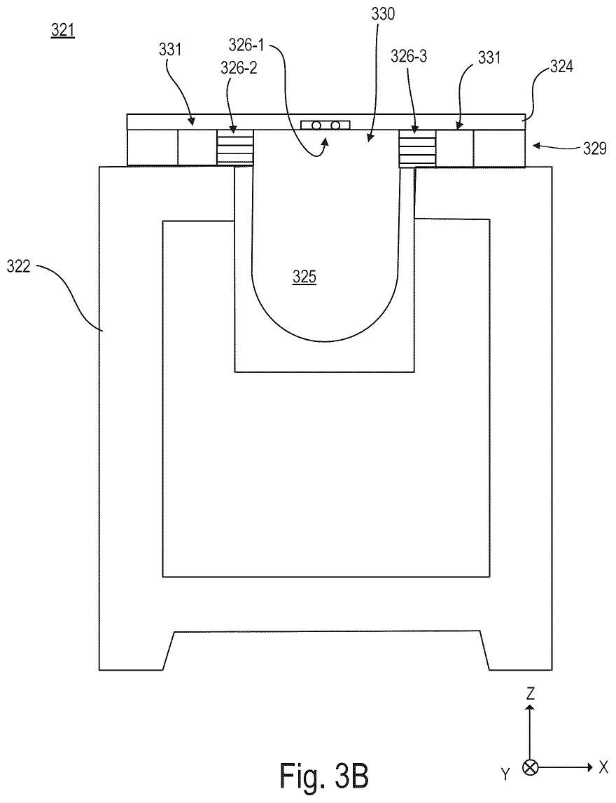

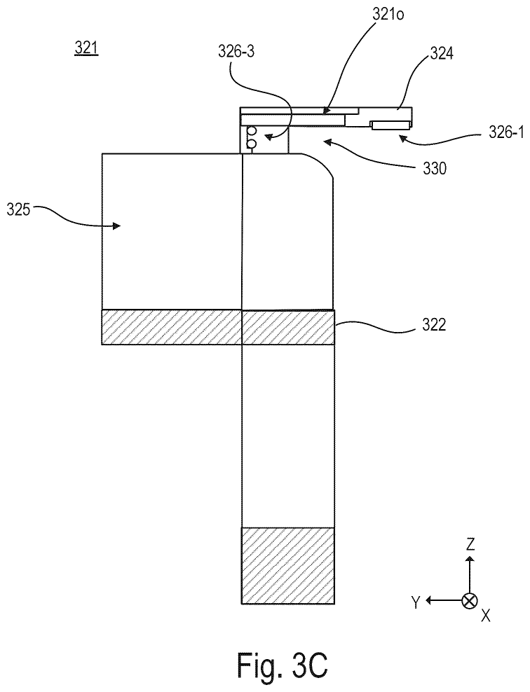

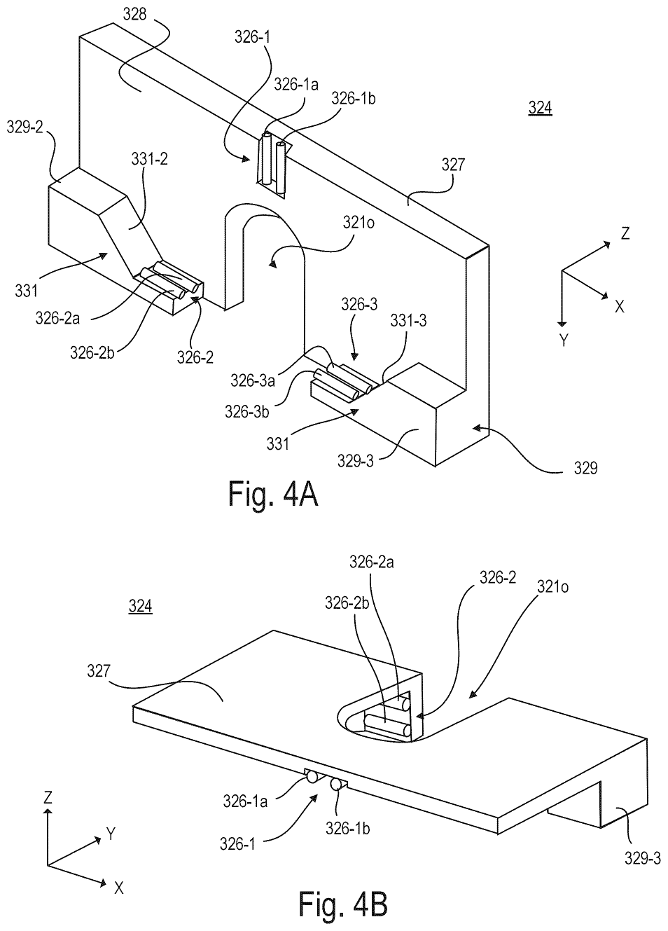

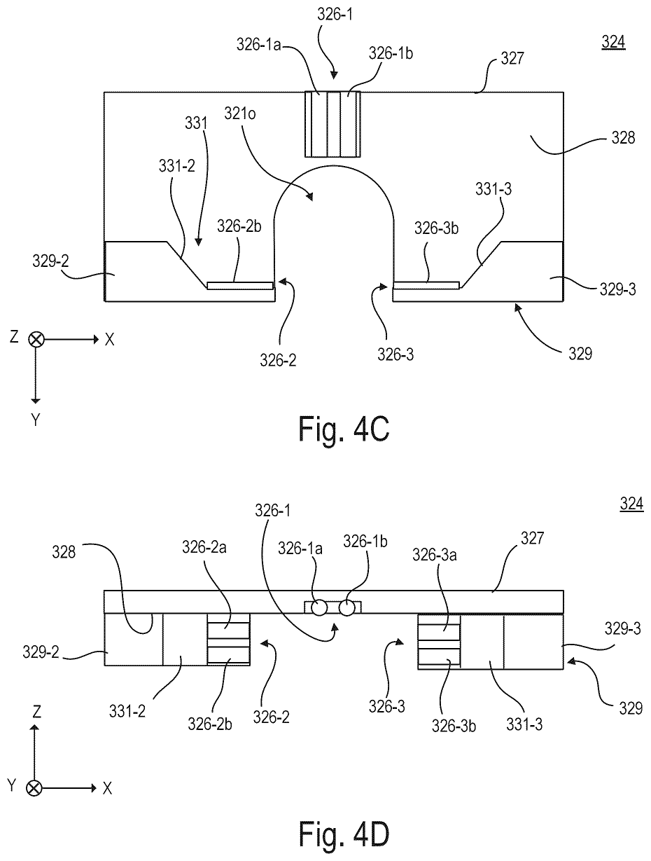

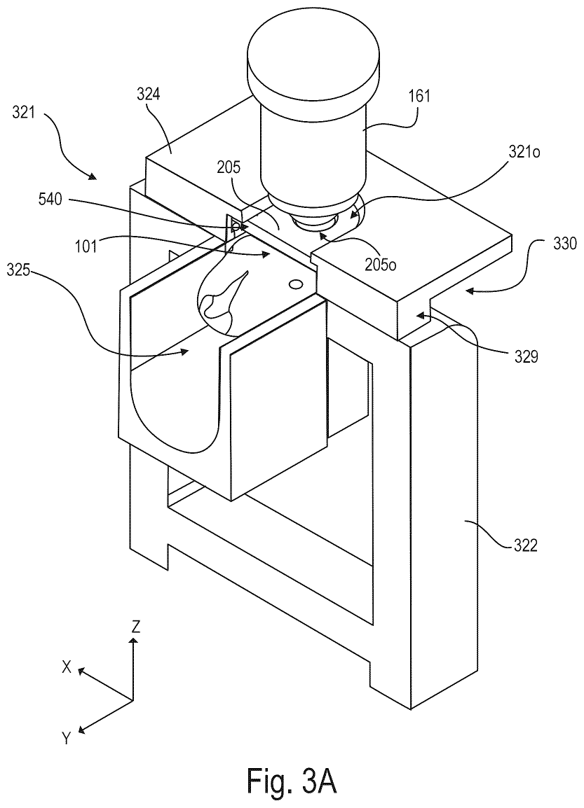

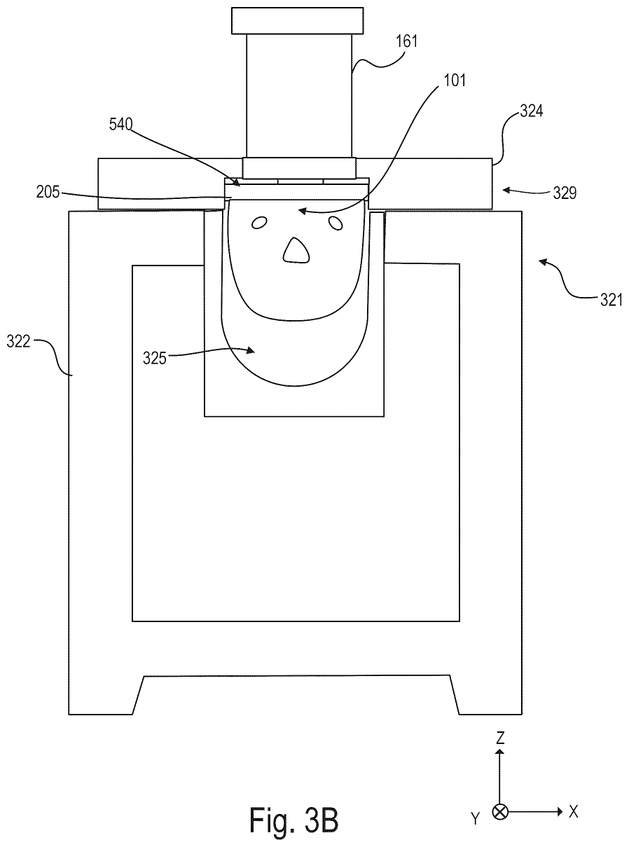

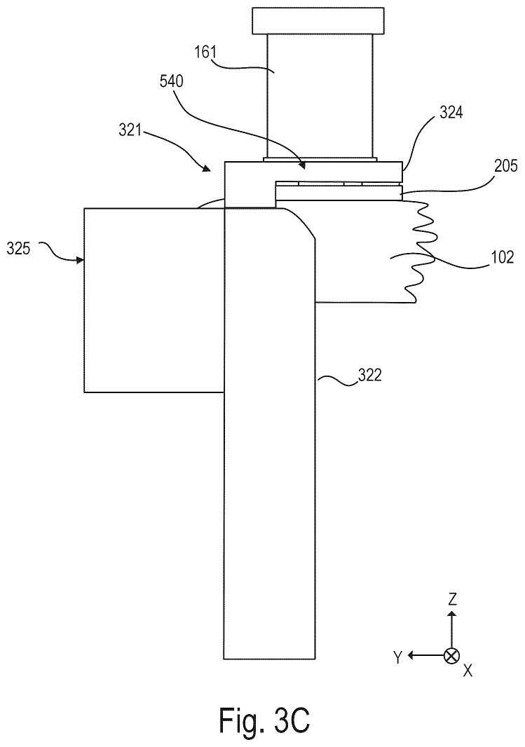

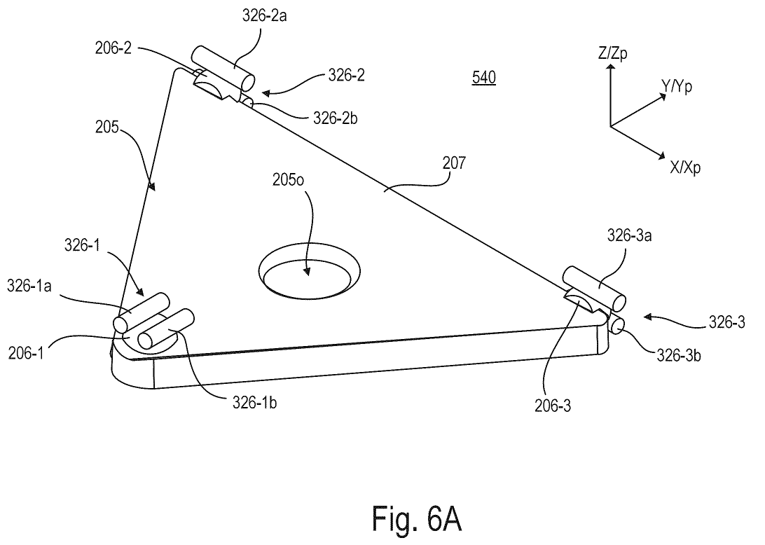

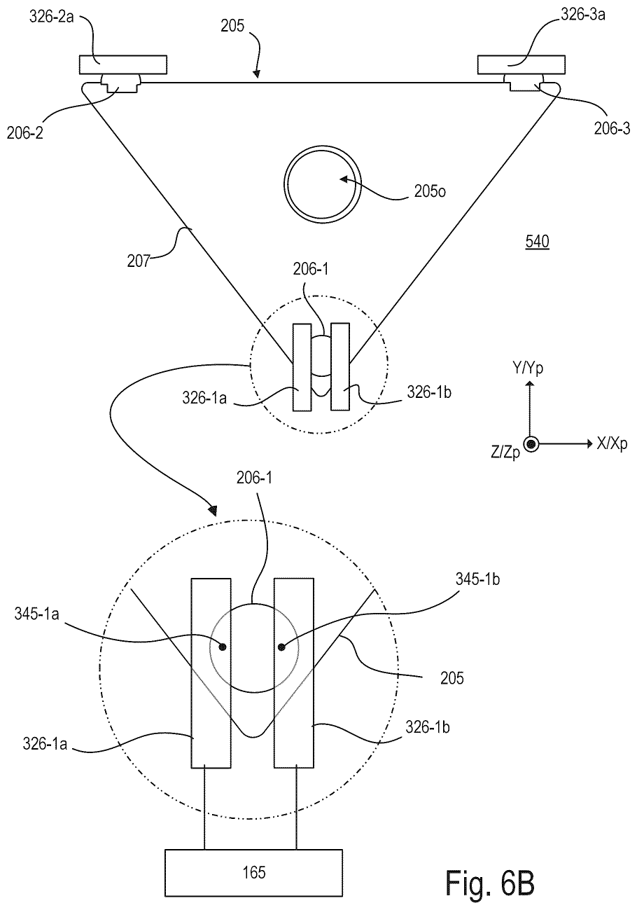

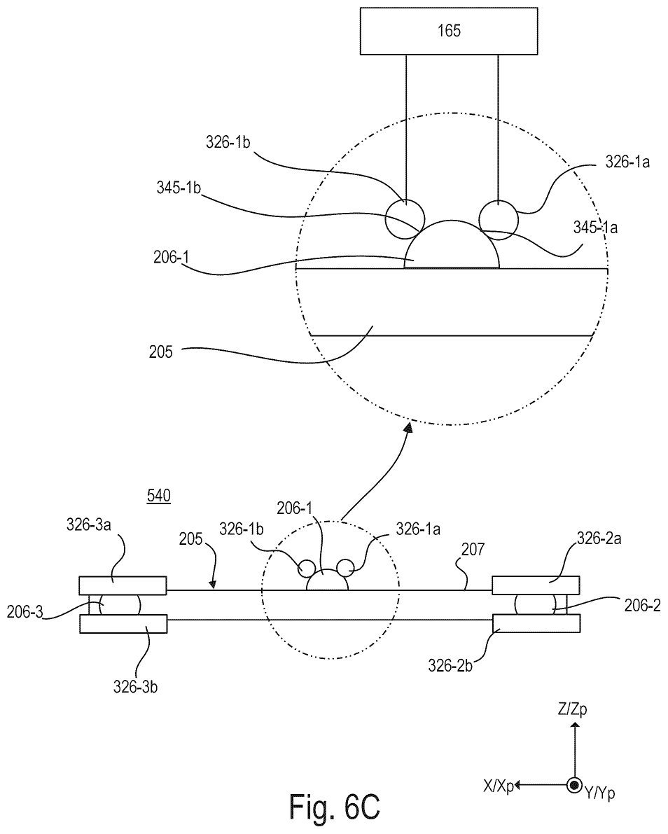

Referring to FIGS. 3A-3C, an implementation 321 of the wall structure 121 is shown and described next, noting that the X, Y, Z coordinate system shown corresponds to the coordinate system of the experimental apparatus 160 to which the wall structure 321 is fixed. The wall structure 321 defines the animal opening 325 that is large enough to accommodate the animal portion 101 and the plate opening 330 having a geometry and size configured to accommodate the animal plate 105, 205. In this implementation, the wall structure 321 includes three second elements 326-1, 326-2, 326-3 (shown more clearly in FIGS. 4A-4D). Each second element 326-1, 326-2, 326-3 is associated with a respective first element 206-1, 206-2, 206-3 (FIGS. 2A-2D) when the animal portion 101 is properly positioned relative to the experimental apparatus 160 (as shown in FIGS. 6A-6C). The wall structure 321 also defines the opening 3210 close to the experimental apparatus 160, the opening 3210 in combination with the opening 2050 of the animal plate 205 (FIGS. 2A-2D) forming the open pathway 162 to enable the experimental apparatus 160 access to the animal portion 101 when the animal plate 205 and the wall structure 321 of the mounting stage 320 are coupled together (as shown in FIGS. 5A-5C).

The wall structure 321 includes or is defined by a base structure 322 and an element structure 324 extending from the base structure 322. The base structure 322 is attached or fixed to the mounting stage 120 and also defines the animal opening 325. The element structure 324 is that portion of the wall structure 321 that defines the plate opening 3210. The second elements 326-1, 326-2, 326-3 are fixed in or formed integrally with the element structure 324 to face the plate opening 3210 such that the second elements 326-1, 326-2, 326-3 can be contacted by the respective first element 206-1, 206-2, 206-3 when the animal portion 101 is properly positioned relative to the experimental apparatus 160.

The base structure 322 and the element structure 324 can be formed as an integral structure. Or, the base structure 322 and the element structure 324 can be formed independently and then attached or fixed together. In both cases, the base structure 322 and the element structure 324 are fixed relative to each other. The wall structure 321, including the base structure 322 and the element structure 324, is made of a rigid and non-reactive material that can be formed into the shape that is needed. For example, the base structure 322 and the element structure 324 can be made of a metal or a metal alloy, a polymer, or a ceramic.

More detailed views of the element structure 324 are shown in FIGS. 4A-4D. The element structure 324 includes a body 327 extending generally along a plane that is parallel with the XY plane of the experimental apparatus 160 (FIGS. 1A-1C). An inner surface 328 of the body 327 faces the plate opening 330. The plate opening 3210 is defined in the body 327. An extension 329 (having portions 329-2 and 329-3) extends along the −Z direction from the inner surface 328 of the body 327 and provides the space needed along the −Z direction to form the plate opening 330.

The second elements 326-1, 326-2, 326-3 are fixed in or formed integrally with the element structure 324 to face the plate opening 3210 such that the second elements 326-1, 326-2, 326-3 contact respective first elements 206-1, 206-2, 206-3 of the animal plate 205 when the animal portion 101 is properly positioned relative to the experimental apparatus 160. Each second element 326-1, 326-2, 326-3 includes a pair cylinders. Specifically, the second element 326-1 includes cylinders 326-1a and 326-1b, the second element 326-2 includes cylinders 326-2a and 326-2b, and the second element 326-3 includes cylinders 326-3a and 326-3b. Each cylinder in a pair of cylinders is aligned with or parallel with the other cylinder in that pair. Moreover, the cylinders in a pair are spaced apart from each other so that they do not touch each other and there is a gap between them. In some implementations, each of the cylinders of each second element 326-1, 326-2, 326-3 is made of a metal or a metal alloy.

With reference also to FIGS. 1A-1C, the mounting or coupling direction is the direction along which the animal 102 moves in order to couple the animal plate 105 with the mounting stage 120. In this case, the mounting or coupling direction is along the +Y axis and the de-mounting or de-coupling direction is along the −Y axis. The cylinders 326-1a, 326-1b of the second element 326-1 are arranged so that their axes are parallel with the mounting direction (the Y axis). The cylinders 326-2a, 326-2b of the second element 326-2 and the cylinders 326-3a, 326-3b of the second element 326-3 are arranges so that their axes are perpendicular with the mounting direction (the Y axis) and therefore perpendicular with the axes of the cylinders 326-1a, 326-1b of the second element 326-1. The arrangement and geometry of each pair of cylinders in the respective second element 326-1, 326-2, 326-3 is selected to enable the coupling with the respective first element 206-1, 206-2, 206-3 when the animal portion 101 is properly positioned relative to the experimental apparatus 160, as discussed below with reference to FIGS. 6A-6C.

The coupling apparatus 100 can also include a guide system 331; the guide system 331 can be formed as a part of the element structure 324, and specifically as a part of the extension 329, as shown in FIGS. 4A-4D. The guide system 331 includes a set or pair of angled walls 331-2, 331-3 in the respective portions 329-2, 329-3 of the extension 329. The angled walls 331-2, 331-3 are tapered along the mounting direction (along the Y axis) such that the surface of each wall 331-2, 332-3 becomes progressively closer along the +Y axis.

Referring to FIGS. 5A-5C, the animal plate 205 and the wall structure 321 of the mounting stage 120 have been mechanically and passively coupled together to form the kinematic mount 540. When the kinematic mount 540 is formed, each first element 206-1, 206-2, 206-3 is passively coupled with its respective second element 326-1, 326-2, 326-3, as shown more clearly in the illustration of FIGS. 6A-6C. Specifically, only the animal plate 205 and the second elements 326-1, 326-2, 326-3 are shown in the illustration of FIGS. 6A-6C to enable a better view of the coupling between the first elements and the second elements. However, it is noted that the second elements 326-1, 326-2, 326-3 are integral with the element structure 324 of the wall structure 321, as shown in FIGS. 4A-4D. When the kinematic mount 540 is formed, the Xp, Yp, Zp coordinate system (of the animal plate 205) is aligned with the X, Y, Z coordinate system of the wall structure 321 (and the mounting stage 120).

Moreover, there is a single point of contact between each spherical portion of the first element 206-1, 206-2, 206-3 and a first cylinder of the respective second element 326-1, 326-2, 326-3 and there is a single point of contact between each spherical portion of the first element 206-1, 206-2, 206-3 and a second cylinder of the respective second element 326-1, 326-2, 326-3. Using the example of the first element 206-1, as shown in the insets of FIGS. 6B and 6C, the first element 206-1 is in the shape of a portion of a sphere and this spherical portion contacts the cylinder 326-1a at a single point of contact 645-1a and contacts the cylinder 326-1b at a single point of contact 645-1b that is distinct from the single point of contact 645-1a. As discussed above, the coupling apparatus 100 can also include the current supply system 165 and the reward system 166. In this implementation, the current supply system 165 is in electrical communication with cylinders 326-1a and 326-1b of the second element 326-1. When the contacts 645-1a and 645-1b are made, then an electrical circuit is completed (as shown in the insets of FIGS. 6B and 6C). Moreover, an electrical circuit can be completed for each pair of first element 206-2, 206-3 and respective second element 326-2, 326-3, where the second elements 326-2, 326-3 are also electrically connected to the current supply system 165. In this way, the reward system 166, which is in communication with the current supply system 165, senses that the animal plate 205 and the wall structure 321 (of the mounting stage 120) are mechanically and passively coupled together to form the kinematic mount 540. The reward system 166 can thereby provide a reward to the animal 102 when it senses that the kinematic mount is formed 540.

As noted above, the only force needed to couple the animal portion 101 relative to the experimental apparatus 160 is the force provided by the animal 102. This force includes a component along the forward direction (the +Y direction). For some animals 102 and geometry of the mounting stage 120, this force can also include a component along the +Z direction in order to enable posterior coupling between the first element 206-1 (which is at the posterior of the animal portion 101) and the second element 326-1. In this example, the −Z direction is the direction of gravity. The component of the force along the +Z direction acts to push the first element 206-1 up into the second element 326-1, so that there is coupling/contact. If the animal 102 moves the posterior of the animal portion 101 down (along the −Z direction), then the first element 206-1 disengages from the second element 326-1.

When the kinematic mount 540 is formed, as shown in FIGS. 5A-5C (and also in FIGS. 6A-6C), the animal 102 to which the animal plate 205 is attached is free to move along a path that is opposite to the mounting direction (the +Y direction). Thus, the animal 102 (and the animal portion 101) is free to move along the −Y direction when the kinematic mount 540 is formed. The animal 102 (and specifically the animal portion 101) is constrained from translating in the mounting direction (the +Y direction), which means that the animal 102 cannot push forward along the +Y direction once the kinematic mount 540 is formed (although the animal 102 can translate along the −Y direction as noted above). Additionally, the animal 102 (and specifically the animal portion 101) is also constrained from moving along any direction in the X axis or the Z axis when the kinematic mount 540 is formed. The animal 102 (and specifically the animal portion 101) is constrained from rotating about an axis that is perpendicular to the imaging plane XY. This means that the animal portion 101 is unable to rotate about the Z axis while the kinematic mount 540 is formed. Moreover, the animal 102 (and specifically the animal portion 101) is constrained from rotating about an axis that is parallel with the mounting direction. This means that the animal portion 101 is unable to rotate about the Y axis while the kinematic mount 540 is formed.

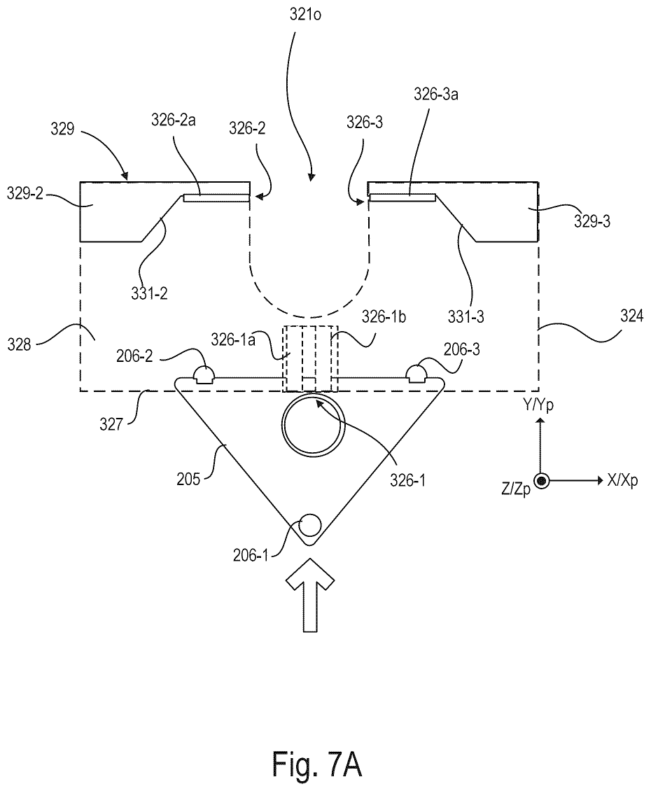

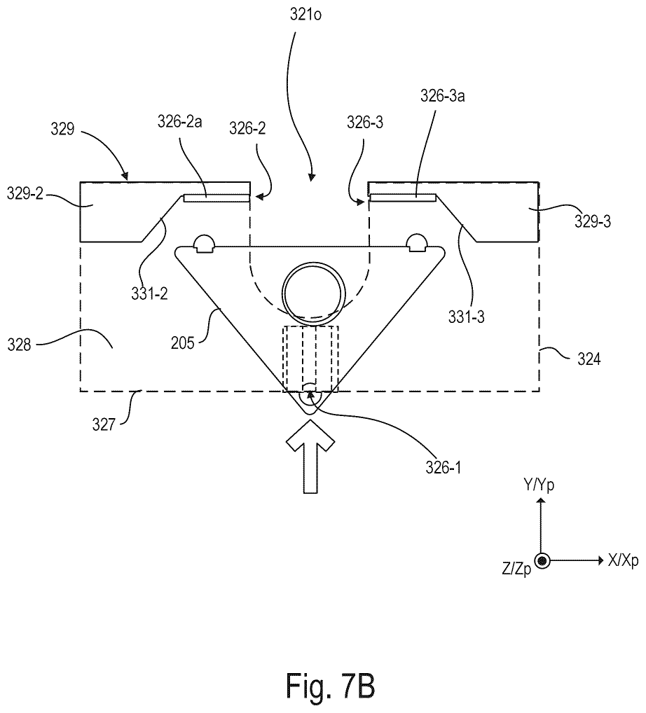

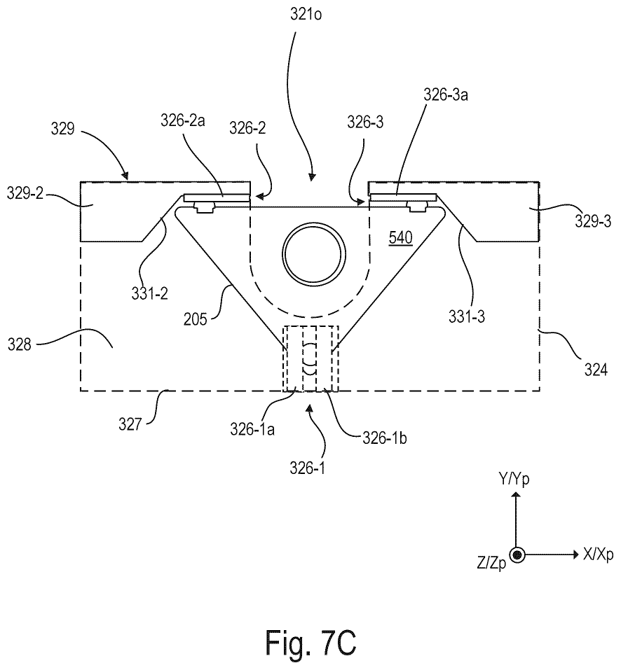

Referring to FIGS. 7A-7C, the guide system 331 provides a rough and gentle guide for the animal 102 to enable the animal 102 to properly seat its animal portion 101 relative to the experimental apparatus 160. As the animal portion 101 of the animal 102 approaches the wall structure 321 along the +Y direction, the animal plate 205 is maneuvered through the plate opening 330. The animal plate 205 eventually enters the region between the angled walls 331-2, 331-3 of the guide system 331, as shown in FIG. 7B. After this, as the animal portion 101 continues to move along the +Y direction, the animal plate 205 is constrained from moving along the +X or −X direction because such motion would cause the ends of the animal plate 205 to contact the angled wall 331-2 or 331-3 (depending on the direction). Moreover, the amount of constraint increases as the animal portion 101 moves along the +Y direction because the walls 331-2 and 331-3 are tapered along the +Y direction. Eventually, the animal portion 101 is prevented from moving any farther along the +Y direction once the kinematic mount 540 is formed, as shown in FIG. 7C. Once the kinematic mount 540 is formed (as shown in FIG. 7C), the animal plate 202 no longer contacts or touches the walls 331-2, 331-3.

Referring again to FIG. 1C (and the examples of FIGS. 2A-6C0, as discussed above, the kinematic mount 140 includes three nodes (where a node is a single pair of a first element and its corresponding second element), with each node including two points of contact. In other implementations, the kinematic mount 140 includes three nodes, with a first node having three points of contact, a second node having two points of contact, and a third node having one point of contact. In still other implementations, the kinematic mount 140 is designed with more than three nodes or only two nodes.

Other implementations are within the scope of the following claims.

What is claimed is:

1. A coupling apparatus for passively positioning a portion of an animal relative to an experimental apparatus, the coupling apparatus comprising:
an animal plate fixed to the animal portion, the animal plate including a plurality of first elements; and
a mounting stage fixed relative to the experimental apparatus, the mounting stage comprising a wall structure defining an animal opening large enough to accommodate the animal portion and a plate opening sized to accommodate the animal plate, the wall structure including a plurality of second elements;
wherein, when the animal portion travels though the animal opening, the animal plate is passively guided through the plate opening until each first element is passively coupled with a respective second element such that the animal plate and the mounting stage are mechanically and passively coupled together to form a kinematic mount.

2. The coupling apparatus of claim 1, wherein the animal portion is the head of the animal and the animal plate is fixed to head.

3. The coupling apparatus of claim 1, wherein each first element of the animal plate is a portion of a sphere.

4. The coupling apparatus of claim 1, wherein each first element is made of a metal or metal alloy.

5. The coupling apparatus of claim 4, wherein each second element is made of a metal or metal alloy.

6. The coupling apparatus of claim 4, wherein each first element is made of a non-magnetic metal or metal alloy.

7. The coupling apparatus of claim 6, wherein each first element is made of a stainless steel or titanium.

8. The coupling apparatus of claim 1, wherein the animal plate includes three first elements and the wall structure includes three second elements, the animal plate having a triangular shape and each of the first elements being fixed at a respective corner of the plate.

9. The coupling apparatus of claim 1, wherein each second element is a pair of parallel-aligned and spaced cylinders.

10. The coupling apparatus of claim 9, wherein each first element is a portion of a sphere, and there is one point of contact between the sphere portion and a first cylinder of the respective pair of cylinders and there is one point of contact between the sphere portion and a second cylinder of the respective pair of cylinders when the sphere portion is passively coupled with the respective pair of cylinders.

11. The coupling apparatus of claim 10, wherein the animal plate includes three first elements and the wall structure includes three second elements.

12. The coupling apparatus of claim 10, wherein the cylinders of a first pair of cylinders have axes that are parallel with a mounting direction and the cylinders of second and third pairs of cylinders have axes that are perpendicular with the mounting direction and perpendicular with the axes of the first pair of cylinders.

13. The coupling apparatus of claim 1, wherein the animal plate and the mounting stage are mechanically and passively coupled together to form the kinematic mount without the use of an external force to couple them together.

14. The coupling apparatus of claim 1, wherein the experimental apparatus is a microscope and the animal plate extends along a plate plane and the plate plane is parallel with an imaging plane of the microscope when the animal plate and the mounting stage are mechanically and passively coupled together to form the kinematic mount.

15. The coupling apparatus of claim 14, wherein, when the animal plate and the mounting stage are mechanically and passively coupled together to form the kinematic mount, the position of the animal portion is fixed with a precision in a range of 1-40 (micrometers) μm in the imaging plane and with a precision in a range of 1-5 μm in a direction perpendicular to the imaging plane.

16. The coupling apparatus of claim 1, further comprising a current supply system in electrical communication with each second element, wherein an electrical circuit is completed between each second element and the respective first element when the animal plate and the mounting stage are mechanically and passively coupled together to form the kinematic mount.

17. The coupling apparatus of claim 1, further comprising a reward system configured to sense when the animal plate and the mounting stage are mechanically and passively coupled together to form the kinematic mount and to provide a reward to the animal when it is sensed that the animal plate and the mounting stage are mechanically and passively coupled together to form the kinematic mount.

18. The coupling apparatus of claim 1, further comprising a guide system configured to passively constrain the animal plate as it is guided through the plate opening.

19. The coupling apparatus of claim 18, wherein the guide system comprises a set of angled walls of the wall structure, the angled walls tapering along a mounting direction.

20. The coupling apparatus of claim 1, wherein, when the animal plate and the mounting stage are mechanically and passively coupled together to form a kinematic mount, the animal is free to move along a path that is the opposite to a mounting direction but the animal is constrained to translate in the mounting direction or along the transverse directions to the mounting directions.

21. The coupling apparatus of claim 20, wherein:
the experimental apparatus is a microscope, and the animal plate extends along a plate plane and the plate plane aligns with an imaging plane of the microscope when the animal plate and the mounting stage are mechanically and passively coupled together to form the kinematic mount; and
the animal is constrained from rotating about an axis that is perpendicular to the imaging plane and is constrained from rotating about an axis that is parallel with the mounting direction when the animal plate and the mounting stage are mechanically and passively coupled together to form the kinematic mount.
